(19) United States
(12) Patent Application Publication
(10) Pub. No.: US 2011/0308958 A1
(43) Pub. Date: Dec. 22, 2011

(54) NICKEL-CONTAINING LAYER ARRANGEMENT FOR INTAGLIO PRINTING

(75) Inventor: Matthias Kurrle, Stuttgart (DE)

(73) Assignee: IPT International Plating Technologies GmbH, Stuttgart (DE)

(21) Appl. No.: 13/223,643

(22) Filed: Sep. 1, 2011

Related U.S. Application Data
(63) Continuation of application No. PCT/EP2010/001504, filed on Mar. 11, 2010.

(30) Foreign Application Priority Data
Mar. 13, 2009 (DE) 10 2009 014 522.2
Sep. 29, 2009 (DE) 10 2009 048 548.1

(51) Int. Cl. C25D 5/48; C10M 103/00; C22C 19/03; B32B 3/30; B32B 3/06

(52) U.S. Cl. 205/221; 428/577; 420/441; 508/103

(57) ABSTRACT

A layer arrangement for a gravure cylinder including nickel in at least a first region through the entire thickness (d) thereof, with a mass fraction of at least 0.80, the arrangement being designed to permit an imaging by means of a laser in the first region and to serve as the outermost layer of the gravure cylinder for intaglio printing. A method for producing a layer arrangement for a printing form wherein the layer arrangement includes nickel in at least a first region through the entire thickness (d) thereof, with a mass fraction of at least 0.80 and at least in the radially external region has a solid lubricant component (X) has the following steps: the layer arrangement is produced on a cylinder core by galvanic coating and a printing image is generated on the layer arrangement for intaglio printing.

### CROSS-REFERENCE TO RELATED APPLICATIONS

This is a Continuation of International Application PCT/EP2010/001504 filed Mar. 11, 2011, which in turn claims priority from German Patent Application DE 10 2009 014 522.2 filed Mar. 13, 2009 and German Patent Application DE 10 2009 048 548.1 filed Sep. 29, 2009, the entire contents of each of which is incorporated herein by reference.

### FIELD OF THE INVENTION

The invention relates to a nickel-containing layer arrangement for intaglio printing.

### BACKGROUND INFORMATION

In intaglio printing, printing cylinders are currently predominantly used with (from the inside to the outside, with the specification of customary layer thicknesses and hardnesses) a thick-walled steel tube with steel journals, a connecting layer made from nickel (1-3 μm), a base layer made from copper (1-2 mm, 100 HV 0.05) and a gravure layer made from copper (80-320 μm, 200 HV 0.05), the imaging (application of the printing image) taking place on the gravure layer. In the case of laser engraving, a zinc layer is additionally applied in advance to the outer copper layer, since there is currently no suitable laser for the laser engraving of copper. After the imaging, a wear protection layer made from hard chromium with a hardness of approximately 1000 HV 0.05 usually applied, in order that the printing cylinder is not destroyed prematurely by the high loading in intaglio printing.

A satisfactory wear protection property of the surface of the printing cylinder is important in intaglio printing, since, in a difference from offset printing, this is usually a direct printing process, in which the engraved printing cylinder (printing form, form cylinder) delivers the ink directly onto the material to be printed. This requires complicated and expensive printing form production with a multiplicity of galvanic baths, for which reason intaglio printing is used, above all, in the case of large runs. The outer layer of a printing form for intaglio printing has to have many properties, such as a precise geometry, satisfactory wear protection properties, suitability for the inks which are used in intaglio printing.

### OBJECT AND SUMMARY OF THE INVENTION

It is an object of the invention to provide a novel layer arrangement for intaglio printing.

According to the invention, the object is achieved by a layer arrangement as recited in claim 1. A layer arrangement of this type facilitates recycling, since it has nickel as a main constituent part of the gravure and a wear protection layer and optionally also of the base layer. It is also suitable for laser engraving. Large layer thicknesses can be achieved by way of a nickel-containing layer arrangement according to the invention, and the ductile behavior under loading is advantageous.

One advantageous development results from claim 3. In a layer arrangement of this type, recycling is particularly satisfactorily possible, since it is substantially a (unmixed) single metal system.

The invention is likewise achieved by a method as recited in claim 13.

Further details and advantageous developments of the invention result from the exemplary embodiments which are described in the following text, are shown in the drawings and are in no way to be understood as a restriction of the invention, and from the subclaims.

### BRIEF DESCRIPTION OF THE DRAWINGS

In the drawings:

FIG. 1 shows a sectional, schematic illustration of a gravure cylinder with a layer arrangement according to the invention as Ballard skin,

FIG. 2 shows a sectional, schematic illustration of a further gravure cylinder with a layer arrangement according to the invention in sleeve technology,

FIG. 3 shows a sectional, schematic illustration of a further gravure cylinder with a layer arrangement according to the invention,

FIG. 4 shows a single-layer layer arrangement according to the invention,

FIG. 5 shows a multiple-layer layer arrangement according to the invention, and

FIG. 6 shows a schematic illustration of a galvanizing installation.

### DETAILED DESCRIPTION

### Mechanical Arrangement of the Nickel-Containing Layer Arrangement

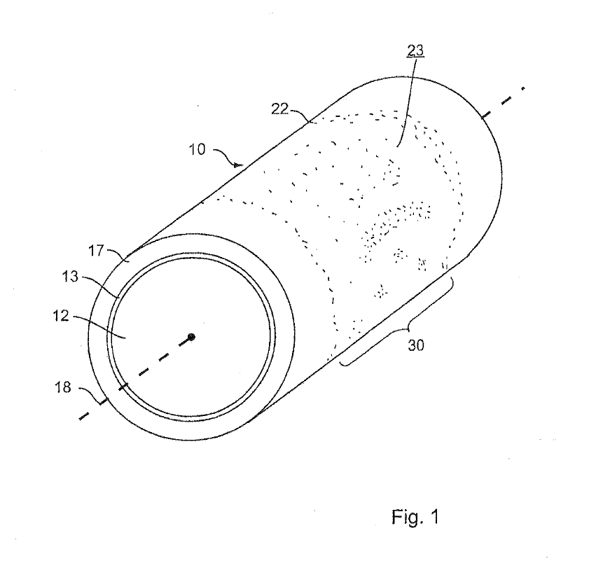

FIG. 1 shows a gravure cylinder (printing form, in general: workpiece) 10 with a core (in general: basic body) 12, a separation layer 13 which is applied on the core, and a layer arrangement 17 which is applied on the separation layer 13. The longitudinal axis 18 of the gravure cylinder 10 is indicated schematically. A cylinder made from steel, copper or zinc is used, for example, as core 12. The core 12 can also be of multiple-layer configuration and can have different shapes. In particular, it can have an additional strike layer/base layer made from nickel or copper.

An set image 23 with cells 22 for intaglio printing is indicated schematically on the shell of the gravure cylinder 10. The set image 23 extends axially over a central region 30 and around the entire shell of the gravure cylinder 10. A typical cell 22 has, for example, a diameter or an extent of 35 μm.

The separation layer 13 serves to prevent a strong adhesive connection between the layer arrangement 17 and the basic body 12, in order thus to make mechanical breaking and subsequent pulling off of the layer arrangement 17 possible in the manner of a Ballard connection is produced between the layer arrangement 17 and the basic body 12.

As separation layer 13, a silver layer, for example, can be applied which oxidizes, or an organic layer (for example, albumen) can be used. The thickness is, for example, a few angstroms (1 Å=10⁻¹⁰ m).

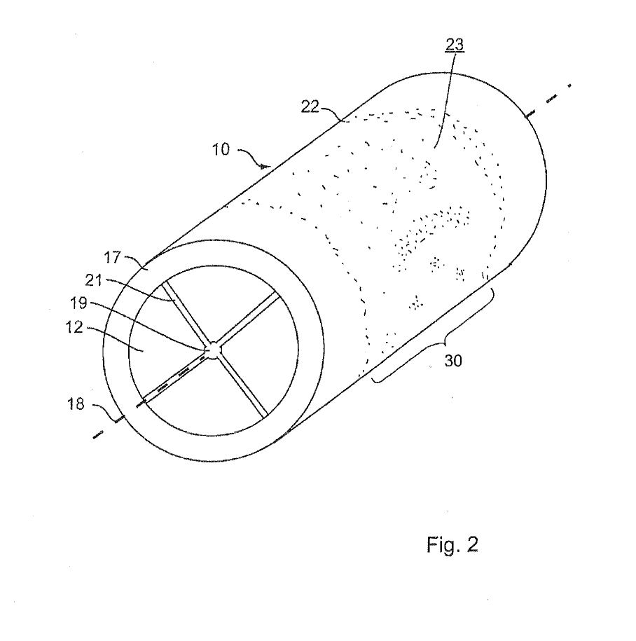

FIG. 2 shows a gravure cylinder 10 with a core 12 and a layer arrangement 17 which is configured as a sleeve (printing plate sleeve). Channels 21 are provided in the core 12, via which channels 21 a vacuum is generated between the core 12 and the layer arrangement 17. To this end, the channels 21 are connected to a central channel 19. The layer arrangement 17 is held on the core 12 during printing by the vacuum. After printing, the sleeve 17 can be pulled off from the core 12 and can therefore be released mechanically from the latter. The layer arrangement 17 can also be provided with an index which runs on the inner side of the sleeve, in order to prevent rotation on the core 12.

The layer arrangement 17 in the form of a sleeve is produced, for example, by a galvanic coating on a mother cylinder (not shown) which is provided with a separation layer, and the layer arrangement is subsequently separated from the mother cylinder, and is pulled off from the latter, by means of excess pressure via channels which are provided in the mother cylinder.

The sleeves can be, for example, of cylindrical or else also slightly conical configuration on the inner side, in order thus to make a frictional connection to the core 12 possible.

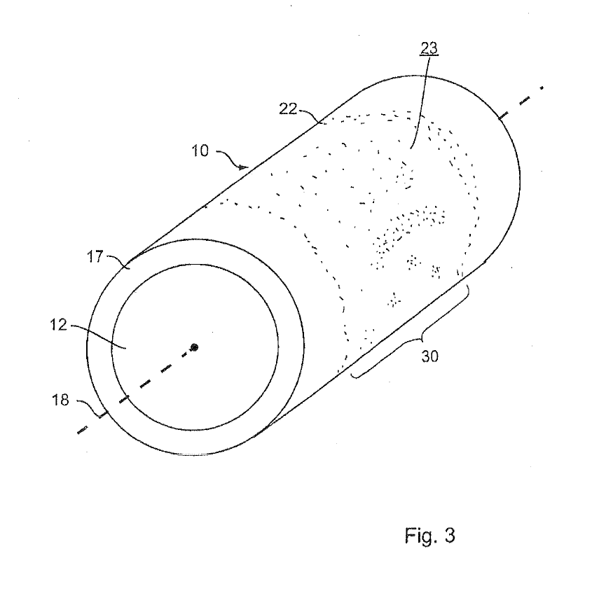

FIG. 3 shows a section through a gravure cylinder 10 with a core 12 and a layer arrangement 17 which is connected adhesively to the core 12, by being deposited on the latter, for example, in a galvanic bath. The layer arrangement 17 therefore cannot be released mechanically from the core and cannot be pulled off from the latter, but rather it has to be removed, for example, by turning and milling.

### Construction of the Nickel-Containing Layer Arrangement

The following comments on the nickel-containing layer arrangement 17 apply to all mechanical arrangements according to the preceding figures, as long as nothing different is specified.

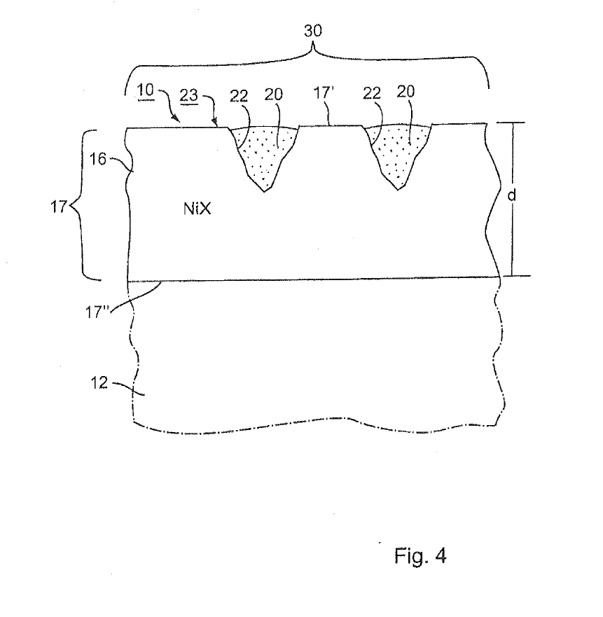

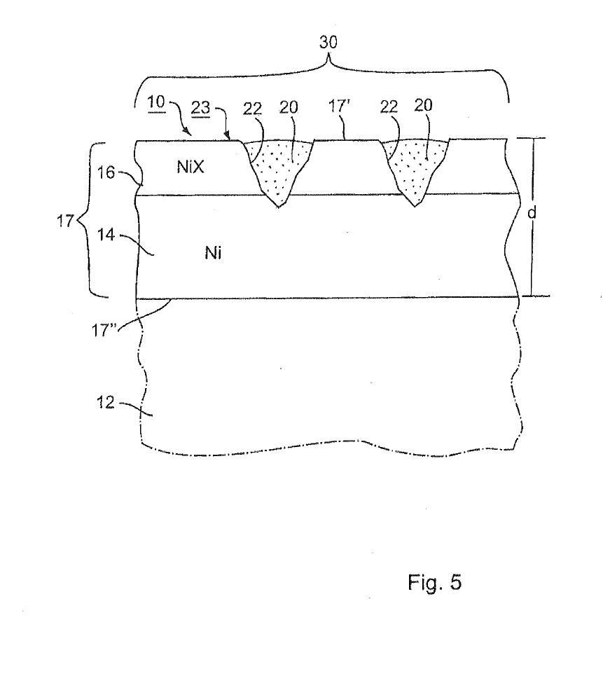

FIG. 4 shows a section through a single-layer nickel-containing layer arrangement 17, and FIG. 5 shows a section through a two-layer or generally multiple-layer (for example, 2, 3, 4 or 5 layers) nickel-containing layer arrangement.

The upper side 17′ corresponds to that shell outer side of the gravure cylinder 10 which is used for printing, and the layer arrangement 17 can be called imaging layer. The lower side 17″ is the inner boundary of the layer arrangement 17.

The layer arrangement 17 has cells 22 which are filled with printing ink 20 for illustrative purposes. In FIG. 5, the cells 22 can extend either only into the NiX layer 16 or else also through the NiX layer 16 into the layer 14 which lies underneath, as a function of the thickness of the NiX layer 16 and the desired depth of the cells 22.

At least in the outer region 16, the layer arrangement consists of a composition NiX which has improved wear protection properties and preferably also poorer wettability in comparison with pure nickel, with the result that the printing ink 20 does not stick in the cells 22 too much. Pure nickel has a relatively high wettability.

In FIG. 5, the layer arrangement 17 has an additional, inner layer 14 made from pure nickel. This has the advantage that the deposition rate in a galvanic coating is higher with nickel than in the case of most of the compositions NiX.

In the composition NiX, the X stands for one or more constituent parts which, together with the nickel, has/have improved wear protection properties in comparison with pure nickel. To this end, the layer made from the composition NiX usually has a lower coefficient of friction than a correspondingly produced layer made from pure nickel. In the case of the constituent parts X, the terms solid lubricant dispersoids, solid lubricants or included solid particles (dispersoids) are used.

The following are examples for suitable non-metallic constituent parts X:
silicon carbide (SiC),
phosphorus (P),
hexagonal boron nitride (h-BN),
boron carbide (B₄C).

The following are examples for suitable constituent parts X which contain a metallic element:
tungsten carbide (WC),
tungsten sulfide (WS₂).

The following are examples for suitable metallic constituent parts X:
silver (Ag) in the form of nanoparticles,
gold (Au) in the form of nanoparticles.

The exclusive use of non-metallic constituent parts X is advantageous, since, in their case, recycling of the metal nickel is simpler than in a multiple metal system. On the other hand, the proportion of constituent parts X is rather low in comparison with the Ni proportion, with the result that recycling is also possible in the case of metallic constituent parts X.

The percentage by weight of the constituent part X in the NiX layer 16, that is to say the relative mass of the constituent part X in the overall mass of the substance mixture NiX, preferably lies between 0.001 and 0.15, more preferably between 0.003 and 0.12, more preferably between 0.01 and 0.10, more preferably between 0.03 and 0.09.

The wear, that is to say the continuous material loss from the surface of a solid body, brought about by mechanical causes, is dependent on a multiplicity of material properties. Wear occurs, for example, as a result of the mechanical contact of the gravure cylinder with the material to be printed which is pressed onto it by the counter pressure roller (impression roller), or with the doctor. No standard process exists for measuring or quantifying the wear. A person skilled in the art will consider the wear protection properties of the outer layer arrangement 17 of a gravure cylinder 10 to be sufficient if, even in the case of the last prints of the desired run, a quality of the print is made possible which corresponds to the specification as agreed with the client. In general, a great hardness, antiadhesive properties and a low coefficient of friction are advantageous for the wear protection properties; wherein it is not sufficient that only one of these properties is particularly satisfactory, but rather the overall properties of the material have to be suitable.

As a function of the galvanic bath which is used, pure, galvanically deposited nickel has a hardness in the range from 350 to 550 HV 0.05, and the NiX preferably has a hardness of at least 450 HV 0.05, for example between 450 and 750 HV 0.05. The hardness constituent part X for increasing the hardness brings about a greater hardness in the composition NiX than in a correspondingly produced layer made from pure nickel. The specification 350 HV 0.05 indicates, for example, that the hardness test according to Vickers with a testing force of 0.05 kp measured a hardness value of 350. 0.05 kp (kilopond) corresponds approximately to the weight of a mass of 50 g, and 1 kp=9.80665 N.

In the case of the Ballard skin (FIG. 1), the layer arrangement 17 preferably has a thickness (radial extent of the layer arrangement) of between 15 μm and 1000 μm, more preferably between 50 μm and 600 μm. If the layer arrangement 17 is configured as a sleeve (FIG. 2), it preferably has a thickness of between 80 μm and 3000 μm, more preferably between 100 μm and 2000 μm.

The imaging of the layer arrangement 17 takes place by the cells 22 being produced, for example, by etching or engraving, in particular laser engraving or electromechanical engraving. Laser engraving is advantageous and possible, for example, with a powerful fiber laser (pulsed or continuous), laser output powers of at least 0.5 kW, preferably of at least 0.85 kW, being advantageous for rapid imaging. The use of other lasers, such as other solid state lasers, is likewise conceivable.

Print tests with different nickel-containing layer arrangements 17 and different printing inks were carried out, and intaglio printing was possible.

### Example 1

A printing cylinder 12 with a diameter of 60 cm, a length of 400 cm and a separation layer 13 (cf. FIG. 1) is coated with a two-layer layer arrangement 17 (cf. FIG. 5). The inner layer 14 has a thickness of 30 μm and consists of pure nickel with a percentage by weight of 1.00, and the NiX layer 16 has a thickness of 5 μm and consists of a composition of nickel with a percentage by weight of 0.96 and phosphorus with a percentage by weight of 0.04.

### Example 2

A two-layer layer arrangement 17 (cf. FIG. 5) is configured as a sleeve with an inner diameter of 80 cm and a length of 350 cm. The inner layer 14 has a thickness of 1100 μm and consists of a composition (alloy) of nickel with a percentage by weight of 0.96 and chromium with a percentage by weight of 0.04. The NiX layer 16 has a thickness of 5 μm and consists of a composition of nickel with a percentage by weight of 0.911, chromium with a percentage by weight of 0.039, and hexagonal boron nitride with a percentage by weight of 0.05.

The metallic constituent part of the NiX layer 16 has a percentage by weight here of 0.911 (nickel)+0.039 (chromium)=0.95 and, in relation to the metallic constituent part, that is to say without consideration of the non-metallic constituent parts, the nickel has a percentage by weight of 0.911/0.95=0.959 and the chromium has a percentage by weight of 0.039/0.95=0.041, and this corresponds substantially to the percentages by weight of the metals in the first layer 14. The mass ratio of chromium to nickel is substantially the same in the NiX layer 16 at 0.0428 (calculated by 0.039/0.911) as in the inner layer 14 at 0.042 (calculated by 0.04/0.96). This has the advantage that the sleeve can be used again after cleaning of the non-metallic additives, since the relative ratio of the percentages by weight of the individual metals to one another (nickel and chromium here, optionally also additional metals) in both layers is similar or substantially identical or identical. As is known to a person skilled in the art, the metal content in the electrolytic baths fluctuates over time, and the expression of the identical nature of the relative ratios of the percentages by weight of the individual metals to one another has to be interpreted correspondingly broadly.

### Example 3

A single-layer layer arrangement 17 (cf. FIG. 4) is configured as a sleeve with an inner diameter of 30 cm. The layer arrangement 17 has a thickness of 2000 μm and consists of a composition of nickel with a percentage by weight of 0.90, phosphorus with a percentage by weight of 0.06 and silicon carbide with a percentage by weight of 0.04.

### Production

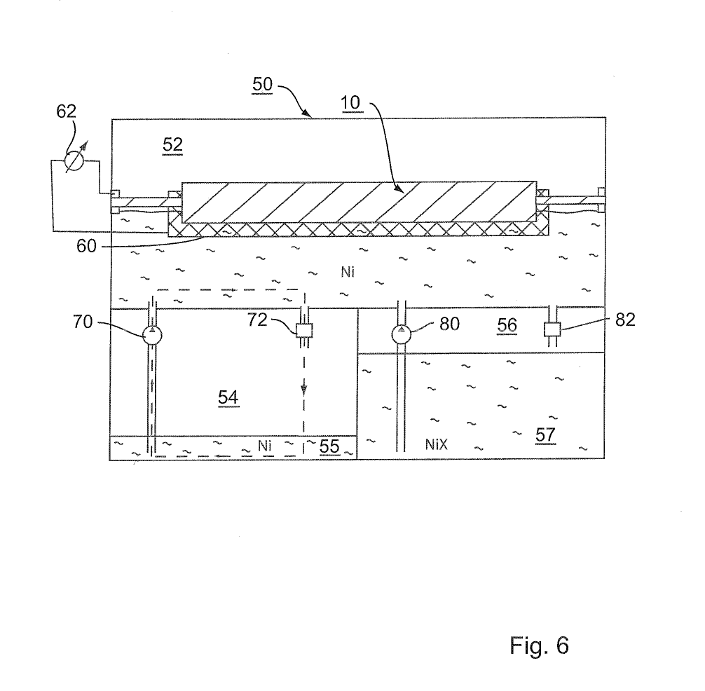

FIG. 6 shows a galvanizing installation 50 with an upper tank 52, in which the gravure cylinder 10 is mounted rotatably, a first lower tank 54 with a galvanic nickel bath 55, and a second lower tank 56 with a galvanic NiX bath 57.

An anode cage 60 is arranged partially around the gravure cylinder 10 and is connected to a voltage or power source 62 which is also connected to the gravure cylinder 10.

A pumping device 70 makes it possible to pump the bath into the upper tank 52, and a valve 72 makes it possible to discharge the bath out of the upper tank into the first lower tank 54. In the same way, a pumping device 80 makes it possible to pump the bath 57 into the upper tank 52, and a valve 82 makes it possible to discharge the bath out of the upper tank 52 into the second lower tank 56.

In the method step shown, the nickel bath is pumped in a circuit via the pumping device 70 into the upper tank 52 and is subsequently discharged into the first lower tank 54 again via the valve 72.

The gravure cylinder 10 is coated galvanically with the inner layer 14 made from nickel; this coating operation is possible, for example, at a relatively high deposition rate of up to 10 μm/min, with the result that a layer thickness of 50 μm requires approximately 5 minutes. The nickel bath is subsequently discharged completely via the valve 72 into the first lower tank 54, and afterward the NiX bath is pumped out of the second lower tank 56 in the same way in the circuit into the upper tank 52, and the coating of the workpiece 10 with the NiX layer 16 takes place. Here, the deposition rate is lower at, for example, up to 5 μm/min, but the NiX layer 16 is thinner than the inner layer 14, with the result that the entire coating of the gravure cylinder 10 with the layer arrangement 17 can take place in approximately from 7 to 30 minutes.

A speed advantage is also achieved by the fact that the same upper tank 52 can be used for both layers, since a galvanic bath 55, 57 with the metal nickel is used in both process steps and thus a contamination of the baths with foreign metals is ruled out, which, in the normal case, would make it necessary to use two separate upper tanks and transport of the gravure cylinder 10.

After the coating, the workpiece is usually polished before the engraving subsequently takes place.

### Imaging and Use of the Layer Arrangement

In the case of the use of a layer arrangement 17 in the form of a sleeve, the imaging can take place, for example, at an external service provider or else directly in the printing plant. In the case of the use of a layer arrangement 17 in the form of a Ballard skin, the imaging of the layer arrangement 17 will preferably take place in the printing plant on account of the high weight of the core 12.

The possibility of imaging the layer arrangement 17 by means of laser engraving is particularly advantageous. After the imaging, no further galvanic coating of the layer arrangement 17 is necessary, but rather the imaged layer arrangement 17 is ready for intaglio printing. This also makes it possible for a printing plant which does not have a galvanic coating installation, to purchase the sleeves externally, to perform imaging in the printing plant, and subsequently to carry out the printing. In contrast with this, at least the galvanic coating with the chromium must still take place in the printing plant in the case of the conventional printing form with a copper base layer, a zinc imaging layer and a chromium wear protection layer.

### Recycling

If the layer arrangement 17 is adhesively connected fixedly to the core 12, it is partially turned or milled on a turning lathe, and a new coating operation can subsequently take place. Those parts of the layer arrangement 17 which are removed by turning can be recycled satisfactorily, since they all mainly consist of nickel.

The use of a mechanically releasable layer arrangement in the form of a sleeve or a Ballard skin is advantageous, since it can then be pulled off completely and recycled.

If a single-layer layer arrangement 17 (FIG. 4) of the NiX type is used, the layer arrangement 17 which has been pulled off can be fed to the galvanic bath again without a metal separation operation, which saves costs.

In the case of a multiple-layer layer arrangement 17 (FIG. 5), it is advantageous to use the same metal or the same or a similar metal combination in the individual layers 14, 16, in order that the separated material, possibly after a cleaning operation, can be used again for coating, and no complicated or to some extent impossible separation of different metals has to take place. This could be called a multiple-layer single-metal system or a multiple-layer system with only one metal alloy (and non-metallic additives X).

If, for example at the end sides, the layer arrangement 17 has rings made from another material (for example, lead) which are used, for example, for stabilizing a sleeve, they are separated at the beginning of the recycling operation. In this case, the layer arrangement 17 has a first region 30 within the two end-side rings, in which first region 30 it has an NiX layer arrangement and optionally also an engraving.

### Process Steps During the Preparation of a Gravure Cylinder

A comparison of the process steps follows between a currently customary preparation of a gravure cylinder and an exemplary use of a layer arrangement according to the invention in imaging with laser engraving.

| | | Nickel-containing layer |
|---|---|---|
| # | Prior art | arrangement 17 |
| 1 | Removal of the | Same |
| | finished form cylinder | |
| | from the gravure | |
| | printing press | |
| 2 | Washing of the form | Same |
| | cylinder for the | |
| | removal of ink | |
| | residues | |
| 3 | Removal of the | — |
| | chromium layer, for | |
| | example chemically | |
| | with hydrochloric acid | |
| 4 | Removal of the copper | Removal of the nickel- |
| | form carrier layer | containing layer |
| | (chemically, | arrangement |
| | galvanically or | |
| | mechanically) | |
| 5 | Preparation for the | Preparation for the |
| | copper plating | coating with the nickel- |
| | (degreasing and | containing layer |
| | deoxidizing, | arrangement (degreasing |
| | application of the | and deoxidizing, |
| | separation layer in | application of the |
| | the Ballard skin | separation layer in the |
| | method) | Ballard skin method) |
| 6 | Galvanic copper | Galvanic coating with the |
| | plating | nickel-containing layer |
| | | arrangement |
| 7 | Surface finishing with | Same |
| | rapidly rotating | |
| | diamond knife head | |
| | and/or with polishing | |
| | stone or polishing | |
| | belt | |
| 8 | Preparation for zinc | — |
| | coating | |
| 9 | Galvanic zinc coating | — |
| 10 | Surface finishing | — |
| 11 | Laser engraving in the | Laser engraving in the |
| | zinc layer (imaging) | nickel-containing layer |
| | | arrangement (imaging) |
| 12 | Test printing (press | Same |
| | proof) | |
| 13 | Cylinder correction, | Same |
| | minus or plus (that is | |
| | to say, reducing or | |
| | increasing cell | |
| | volume) | |
| 14 | Preparation for the | — |
| | chromium plating | |
| | (degreasing and | |
| | deoxidizing; | |
| | preheating, if | |
| | necessary; optionally | |
| | polishing) | |
| 15 | Galvanic chromium | — |
| | plating | |
| 16 | Surface finishing with | Same |
| | fine polishing stone | |
| | or paper | |
| 17 | Delivery of the | Same |
| | finished cylinder to | |
| | the store or directly | |
| | to the gravure | |
| | printing press | |

In this list, the galvanic baths for the coating with the connecting layer of nickel and the base layer from copper are not yet taken into consideration, which are not required during every reuse of the printing cylinder.

The comparison can look as follows from the viewpoint of a printing plant which purchases unimaged sleeves and images them in house with laser engraving:

| | | Nickel-containing layer |
|---|---|---|
| # | Prior art | arrangement 17 |
| 1 | Laser engraving into | Laser engraving into the |
| | the zinc layer | nickel-containing layer |
| | (imaging) | arrangement (imaging) |
| 2 | Test printing (press | Same |
| | proof) | |
| 3 | Cylinder correction, | Same |
| | minus or plus (that is | |
| | to say, reducing or | |
| | increasing cell | |
| | volume) | |
| 4 | Preparation for the | — |
| | chromium plating | |
| | (degreasing and | |
| | deoxidizing; | |
| | preheating, if | |
| | necessary; optionally | |
| | polishing) | |
| 5 | Galvanic chromium | — |
| | plating | |
| 6 | Surface finishing with | Can be omitted |
| | fine polishing stone | |
| | or paper | |
| 7 | Delivery of the | Same |
| | finished cylinder to | |
| | storage or directly to | |
| | the gravure printing | |
| | press | |

The printing plant can therefore manage without an installation for galvanic coating if a nickel-containing layer arrangement 17 is used, which also makes the method interesting for relatively small printing plants as well.

Ni h-BN

Tests have shown that an Ni h-BN layer 16 made from a composition of nickel and hexagonal boron nitride(h-BN) has very satisfactory wear protection properties and therefore can be used as a replacement for a wear protection layer made from hard chromium, for example during the coating of gravure cylinders.

The hardness of approximately from 450 to 600 HV 0.05 is similarly large to that in an NiP layer, but is lower than that of hard chromium (up to 1200 HV 0.05).

A great advantage of the Ni h-BN layers consists of a large reduction in the coefficient of friction, in particular of a reduction in the dry friction. The reduction in the coefficient of friction leads to the wear protection properties being similarly satisfactory as in the case of hard chromium, depending on the application. In the case of a lack of lubrication, scuffing friction occurs rapidly in the case of tribologically loaded pure nickel, and this is prevented or at least reduced by the reduction in the coefficient of friction which is achieved by the Ni h-BN layer. The advantage of the satisfactory reduction in the coefficient of friction is more important in relation to the scuffing friction than the disadvantage of lower hardness. An addition of further particles such as SiC is advantageous.

The percentage by weight of the hexagonal boron nitride 17 in the NiX layer 16 is preferably between 0.001 and 0.08, more preferably between 0.002 and 0.07, and more preferably between 0.01 and 0.05.

Production of Ni h-BN

The production of an Ni h-BN layer was successfully carried out by galvanic coating with the following solution preparation:
500 g/l nickel sulfate (NiSO₄.7H₂O)
30-45 g/l boric acid (H₃BO₃)
15-35 ml/l organic grain refining agent/hardness component, for example saccharine
10-50 ml/l additive, for example h-BN and/or further additives.

Since the hexagonal boron nitride does not dissolve in the bath, it is advantageous to use a ready-made aqueous h-BN suspension with a wetting agent in the production of the galvanic bath, as is commercially available, and the galvanic bath has to be set in motion during the galvanizing operation. In tests, a nickel content in the electrolytic bath of approximately 110 g/l and a pH value in the range from 1.7 to 4.5 have proven advantageous.

In the case of an Ni h-BN layer or in the case of another layer deposited from an aqueous dispersion. The term dispersion layer can also be used.

The specified solution formulation can also be used for the other mentioned NiX layers, the respective X proportion being added as an additive with the desired concentration.

### Example 4

A satisfactorily adhering Ni h-BN layer on a degreased, activated and deoxidized copper pin has resulted with the following bath composition:

300 g/l nickel sulfate
40 g/l boric acid
2.6 g/l saccharine
20 g/l h-BN

The stated solids were dissolved in water. The temperature was 60° C. and the pH value was 2. The current program for the galvanization was 2 minutes at 2.5 A/dm² for a smooth layer and subsequently 10 minutes at 30 A/dm² (depending on the desired layer thickness).

A wide variety of amendments and modifications are naturally possible within the scope of the present invention.

Thus, for example, the hardness and also the wear protection properties can be improved by a thermal treatment of the layer arrangement 17.

Chemical production (“chemical nickel”) can also be carried out instead of the galvanic production of the layer arrangement 17.

1. A layer arrangement for a gravure cylinder comprising nickel with a percentage by weight of at least 0.80 over its entire thickness (d) in at least one first region, the layer arrangement being configured for making imaging by means of a laser possible in the at least one first region, and the layer arrangement being configured for serving as the outermost layer of the gravure cylinder in intaglio printing.

2. The layer arrangement as claimed in claim 1, wherein the layer arrangement comprises a solid lubricant constituent part (X) in the first region at least in the radially outer region, preferably over its entire thickness.

3. The layer arrangement as claimed in claim 2, wherein the solid lubricant constituent part (X) comprises at least one of phosphorus (P), silicon carbide (SiC), boron carbide (B₄C), hexagonal boron nitride (h-BN) or another non-metallic solid lubricant constituent part.

4. The layer arrangement as claimed in claim 2, wherein the solid lubricant constituent part (X) comprises at least one of tungsten carbide (WC), tungsten sulfide (WS₂), silver (Ag), gold (Au) or another solid lubricant constituent part with a metallic element.

5. The layer arrangement as claimed in claim 2, wherein the layer arrangement has a hardness of at least 400 HV 0.05 in the radially outer region.

6. The layer arrangement as claimed in claim 1, wherein the layer arrangement is produced in the first region by galvanic deposition.

7. The layer arrangement as claimed in claim 1, wherein the layer arrangement is configured for making imaging by electromechanical engraving possible in the first region.

8. The layer arrangement as claimed in claim 1, wherein the layer arrangement has a set image in the first region.

9. The layer arrangement as claimed in claim 1, wherein the layer arrangement is configured as a Ballard skin for connecting releasably to a cylinder core of the gravure cylinder.

10. The layer arrangement as claimed in claim 9, wherein the layer arrangement has a thickness in the first region of between 15 μm and 1000 μm, preferably between 50 μm and 600 μm.

11. The layer arrangement as claimed in claim 1, wherein the layer arrangement is configured as a sleeve for connecting releasably to a cylinder core of the gravure cylinder.

12. The layer arrangement as claimed in claim 11, wherein the layer arrangement has a thickness in the first region of between 80 μm and 3000 μm, preferably between 100 μm and 2000 μm.

13. A method for producing a layer arrangement for a printing form, the layer arrangement comprising, in at least one first region:
nickel with a percentage by weight of at least 0.80 over its entire thickness (d), and
a solid lubricant constituent part (X) at least in the radially outer region,
which method comprises the steps of:
A) producing the layer arrangement by galvanic coating on a cylinder core; and
B) producing a printing image for intaglio printing on the layer arrangement by engraving.

14. The method as claimed in claim 13, wherein the layer arrangement is used for intaglio printing without a further galvanic coating after the production of the printing image.

15. The method as claimed in claim 13, wherein the layer arrangement is recycled, by its material being used to produce one or more new layer arrangements.
